(19) United States
(12) Patent Application Publication
(10) Pub. No.: US 2009/0084573 A1
(43) Pub. Date: Apr. 2, 2009

(54) DEVICE FOR PROTECTING ELECTRICAL APPARATUS AND A GROUP OF PARTS INCLUDING SAID DEVICE

(75) Inventor: Fabrizio Fabrizi, Bergamo (IT)

Correspondence Address: SEED INTELLECTUAL PROPERTY LAW GROUP PLLC, 701 FIFTH AVE, SUITE 5400, SEATTLE, WA, 98104, US

(73) Assignee: BTICINO S.p.A., Milano (IT)

(21) Appl. No.: 12/280,299

(22) PCT Filed: Jan. 31, 2007
(86) PCT No.: PCT/IT2007/000062

§ 371 Date: Nov. 20, 2008

(30) Foreign Application Priority Data
Feb. 27, 2006 (IT) RM2006A000099

(51) Int. Cl. H02G 3/14

(52) U.S. Cl. 174/67

(57) ABSTRACT

Protection device for protecting at least one electrical apparatus which can be fixed to a wall by means of a supporting frame including a main body provided with at least one mounting window suitable to receive said electrical apparatus, characterized in that the protection device includes: a base part, removably applied to the supporting frame, provided with at least one through opening suitable to interact with said at least one mounting window; and a protective part, connected to the base part, surrounding the through opening so as to define at least one protection chamber provided with one open side and such as to internally house at least one frontal portion of said electrical apparatus.

### BACKGROUND

1. Technical Field

The present invention relates to the technical field of electrical systems for houses and offices and, more particularly, relates to a device for protecting electrical apparatus.

2. Description of the Related Art

For the purposes of the present description, electrical apparatus shall mean, in general, any electrical means or device whatsoever forming part of electrical systems in civil buildings or similar and usually intended to be mounted, for example built-in, on the walls of said buildings.

Therefore, this definition includes, but is not limited to, switches, power supply sockets, data network sockets, TV sockets, telephone sockets, push buttons, change-over switches, deviator switches, electrical regulation devices in general, connectors, thermostats, timers, fuse carriers, ringers/buzzers, emergency lamps for example removable, signaling lamps, displays for example LCD and similar.

As is known, most of the above mentioned electrical apparatus is usually installed on the wall using composite mounting structures, or groups of parts, generally including:
a box intended to be embedded in the wall;
an apparatus-holding mounting frame (or supporting frame) which can be fixed to the box and comprising a frame body which extends around at least one opening defining a mounting seat suitable to receive and hold one or more electrical apparatuses; and
a removable covering plate which can be fixed to the frame and provided with an opening to make it possible for the user to access, visually or manually, the electrical apparatus installed on the supporting frame.

As is known, the electrical apparatuses of an electrical system in a building are usually intended to be installed on the supporting frames, for example fixed to respective boxes embedded in the walls of the building, before the finishing work on the building has been completed.

For example, it often happens that the supporting frames and respective electrical apparatuses are installed on the wall before the walls are painted, or before the windows and doors are mounted, or before the floor has been finished, or before the furniture has been transported and arranged inside the rooms forming the building. This situation is a consequence of the demand, or need, to finish in substance and make available the electrical system before carrying out numerous other finishing works on the building.

In order to avoid damaging the covering plates during said finishing works, normally the plates are installed on their respective supports only after the finishing works have been substantially completed.

However, it frequently happens that, during the finishing works, said electrical apparatuses mounted on the supporting frames suffer damage of various kinds. For example, because of the presence and coming and going in the rooms of the building of numerous workmen (carpenters, plumbers, marble workers, decorators, etc.) and because of the numerous tools (drills, brooms, buckets), materials (paints, solvents, powders, liquids in general etc.) and objects (ladders, furniture, trolleys) which are used and moved around by said workmen inside the building, it frequently happens that parts of the electrical apparatuses normally intended to remain visible while they are being used, are irremediably damaged by scratches, more or less superficial, by accumulation of dust and by contact with staining or abrasive substances. In some cases, this damage is of an aesthetic nature, in the sense that it alters the superficial aspect of the electrical apparatuses while, in other more serious cases, it is such as to irremediably compromise the functioning of said apparatuses.

Despite the need to protect the electrical apparatuses from the above mentioned damage, the prior art does not provide many solutions to said problem. Furthermore, these solutions have often demonstrated their inefficiency and inconvenience. For example, a solution is known which suggests associating the covering plate to the supporting frame once the electrical apparatuses have been wired and fixed to the frame and covering the resulting light-point (or control point) with a protective adhesive film and in plastic material which substantially covers all the free surface of the light-point. In this way, it is possible to protect both the covering plate and the visible part of the electrical apparatuses. However, this solution has the following drawbacks:
it is necessary to install the covering plates before carrying out the remaining finishing works, while the recent tendency is to leave it to the final user of the building to choose and buy the covering plates even after completion of the finishing works and furnishing;
the protective film prevents access to the electrical apparatuses so that, for example, the power supply sockets cannot be used during the finishing works unless the protective film is previously removed or perforated;
in the case a sharp-edged object inadvertently bangs against the film, this can easily be lacerated with serious risk of damaging both the electrical apparatus and the covering plate.

### BRIEF SUMMARY

The object of the present invention is to provide a device which makes it possible to satisfy the need to protect the electrical apparatuses during finishing works and which, at the same time, makes it possible to overcome the above-described drawbacks of the known art solutions.

Said object is reached by means of a protection device as described in the attached claim 1 in its most general embodiment and some preferred embodiments as defined in the dependent claims.

A group of parts as defined in the attached claim 9 also forms part of the present invention.

### BRIEF DESCRIPTION OF THE SEVERAL VIEWS OF THE DRAWING(S)

Further features and advantages of the present invention will become more apparent from the following detailed description of an exemplary but non-limiting embodiment thereof, as illustrated in the accompanying drawings, in which:

FIG. 1 shows a front elevation of a supporting frame for electrical apparatuses to which a protection device according to the present invention can be associated;

FIG. 2 shows a prospective view of a particularly preferred embodiment of a protection device according to the present invention;

FIG. 3 shows a prospective view of a group of parts including the protection device in FIG. 2 applied to the supporting frame in FIG. 1;

FIG. 4 shows a prospective view of the group of parts in FIG. 3 with, in addition, three electrical apparatuses fixed to the supporting frame;

FIG. 5 shows a utilization embodiment of the group of parts in FIG. 4;

FIG. 6 shows a prospective view of an accessory which can be associated to the protection device in FIG. 2; and

FIG. 7 shows a prospective view of the accessory in FIG. 6 associated to the group of parts in FIG. 4.

### DETAILED DESCRIPTION

In the figures, equal or similar elements will be indicated with the same reference numbers.

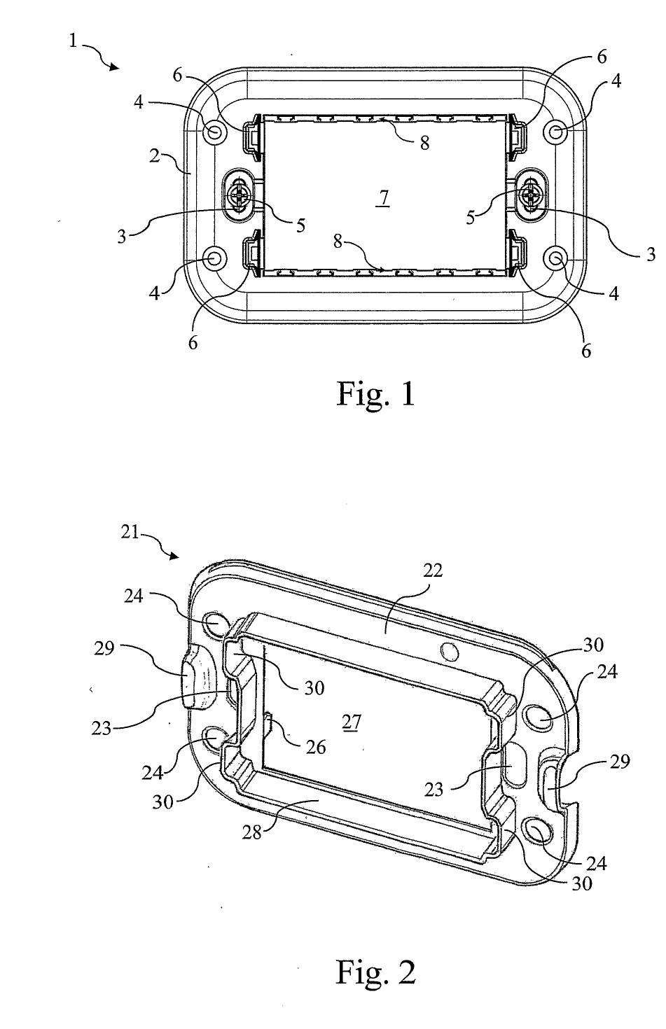

FIG. 1 illustrates a particular embodiment of a supporting frame 1, which can be applied to a wall, so as to mount on said wall one or more electrical apparatuses not shown in FIG. 1.

The supporting frame 1 includes an essentially frame-shaped body, typically made with insulating material and having approximately the shape of a substantially plate-like frame, for example with a quadrangular plan with rounded edges. In the particular embodiment illustrated, the body of the frame 1 is shown with a substantially rectangular shape with rounded edges.

The supporting frame 1 includes wall fixing means 3, 4 so as to fix the supporting frame 1 to the wall. In the embodiment of the supporting frame illustrated in FIG. 1, said fixing means include two slotted through holes 3, provided in the body 2 of the frame 1 so as to fix, by means of screws 5 or equivalent means, said frame to a box, not shown in the figure, embedded in the wall, for example in the case said wall is a thick wall in masonry (i.e., a wall where it is possible to embed a box). The wall fixing means 3, 4 also include a further 4 holes (through holes or preformed holes), so as to fix the frame 1, by means of screws or equivalent means, directly to the wall, i.e., without the use of a box. For example, this situation arises in practice when the fixing wall is not a masonry wall but is, for example, a panel so it is not possible to embed a box in said wall.

The supporting frame further includes coupling means 6 to connect the frame 1 to a covering plate, not illustrated in FIG. 1. In the embodiment shown in FIG. 1, said coupling means include, but are not limited to, four coupling grooves 6 suitable to receive respective fixing tongues provided in the covering plate.

As is known to the skilled in the art, the role of the covering plate is not only to guarantee minimum protection of the electrical apparatuses, for example from dust, but also to prevent dangerous access (for example with a pointed object) to the electrically conductive parts of the electrical apparatuses. Another fundamental purpose of the covering plates is also to mask unattractive blemishes caused, for example, by the presence of the box and the supporting frame which, rather than an aesthetic value, have a functional value.

The body 2 of the frame 1 extends around at least one main opening 7, defining a mounting window 7 such as to receive or hold one or more electrical apparatuses, not illustrated in FIG. 1. A plurality of coupling elements 8 project from the body 2 of the supporting frame towards said opening 7, preferably along two parallel sides of the body 2 of the frame which define said opening 7. Said coupling elements 8 are such as to interact with corresponding coupling elements provided on two opposite sides of the electrical apparatuses to be coupled to the supporting frame 1. Typically, the coupling elements 8 permit coupling of the snap-in and lock-in type of the electrical apparatuses to the supporting frame 1.

FIG. 2 shows a particularly preferred embodiment of a removable protection device, generally indicated with 21, which can be applied to a supporting frame 1 (like, for example, the supporting frame 1 illustrated in FIG. 1) for protecting electrical apparatuses intended to be fixed to said frame 1.

The protection device 21, is preferably made of hard plastic and more preferably of recyclable plastic.

The protection device 21 includes a base part 22 intended to face the main body 2 of the supporting frame 1, when the protection device is applied to the supporting frame 1.

The base part 22 of the protection device 21 extends around a through opening 27, substantially central, provided in the base part 22 to interact with the mounting window 7 of the supporting frame 1. In other words, the through opening 27 and the mounting window 7 are substantially coaxial and co-extended.

In the particularly preferred embodiment illustrated in FIG. 2, the base part 22 is designed like a substantially plate-like grill, having the shape of a frame which extends around the through opening 27 and which is substantially counter-shaped compared to the main body 2 of the supporting frame 1. In practice, in said embodiment, the base part 22 of the protection device 21 envelops like a shell the main body 2 of the supporting frame 1.

The base part 22 of the protection device 21 includes fixing means 26 for removably applying the protection device 21 to the supporting frame 1. Preferably, said fixing means 26 are lock-in fixing means and preferably snap-in. In this way, the operations of applying and removing the protection device 21 to and from the frame 1 are particularly simple and quick since they do not require any specific tool.

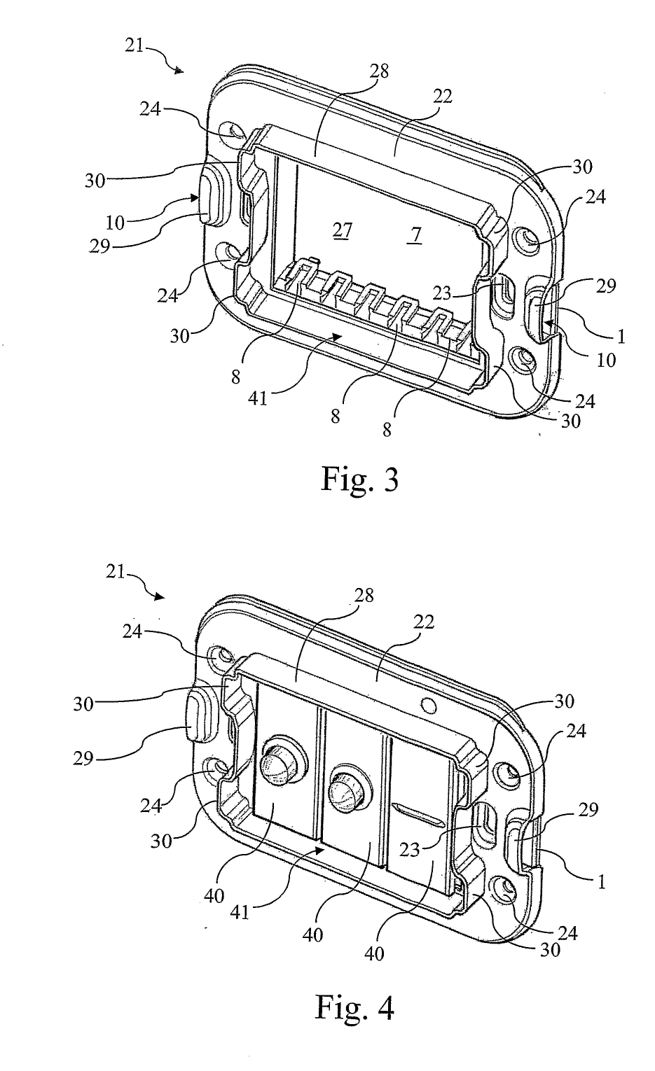

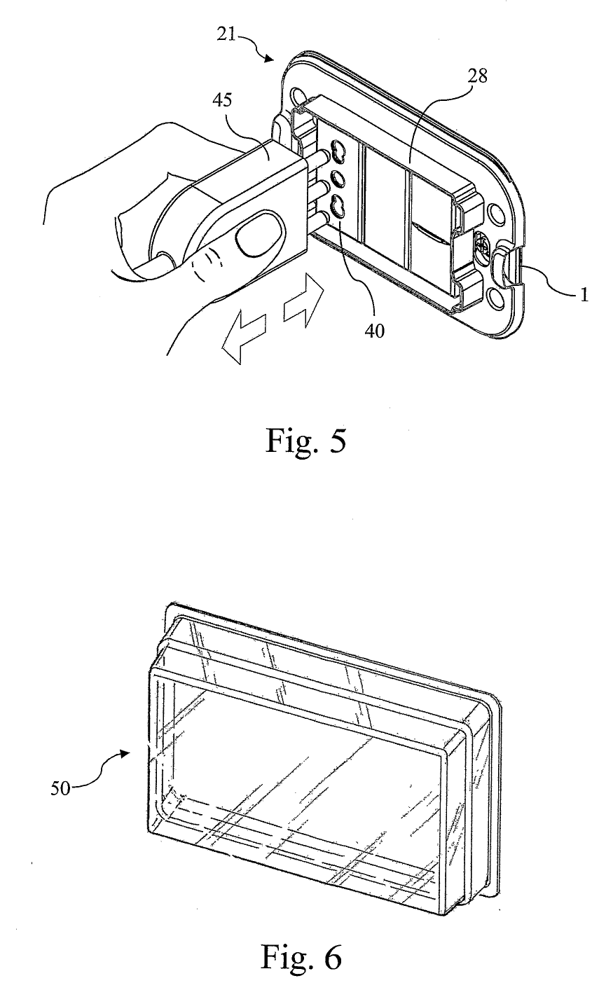

In a particularly advantageous embodiment, in order to simplify even further removal of the protection device 21 from the supporting frame 1 to which it is applied, shaped holding means 29 are provided in the protection device 21 and, preferably, in a peripheral portion of its base part 22, such as to provide a manual grip for the operator who wishes to carry out the removal operation manually, i.e., without the use of tools. As can be better seen in FIG. 3, where the protection device 21 is applied to the supporting frame 1, said holding means 29 are preferably shaped in such a way as to define, between the base part 22 of the protection device 21 and the supporting frame 1, opposing spaces 10 such as to make it possible to insert the top of a finger into each of said spaces, in order to remove the protection device 21 from the supporting frame 1.

In a particularly advantageous embodiment, the fixing means 26 of the protection device 21 are intended to interact with corresponding complementary fixing means 6 provided in the supporting frame 1 for mounting of the covering plate. This stratagem has the advantage that it is unnecessary to provide in the supporting frame 1 further fixing means for the application of the protection device 21 to said frame. For example, in the particularly preferred embodiment of a protection device 21 illustrated in FIG. 1, said fixing means are represented by a plurality of projecting tongues 26 intended to be inserted into respective fixing grooves 6 provided on the body 2 of the supporting frame 1, for fixing a covering plate (not shown in the figures) to the supporting frame 1. In FIG. 2 only one of said projecting tongues is visible, however it is preferred the protection device 21 in FIG. 2 includes, for example, a number of tongues corresponding to the number of grooves 6 provided in the supporting frame 1 in FIG. 1.

In one alternative embodiment, a fastener, such as a screw can be used to connect device 21 to frame 1, or the four snap in clips 26 can clip into the four grooves of the frame 1.

In a particularly advantageous embodiment, the base part 22 includes a plurality of through holes 23, 24 interacting with respective holes 3, 4 provided in the body 2 of the supporting frame 1 for fixing the supporting frame 1 to the wall where it is intended to be installed. Said through holes 23, 24 are shaped in such a way that the protection device 21, if applied to the frame 1, does not interfere with the fixing means, for example the screws 5, used for fixing the supporting frame 1 to the wall. Advantageously, this stratagem makes it possible to install the supporting frame 1 on the wall when the protection device 21 is applied to the supporting frame 1 and to remove the protection device 21 from the supporting frame 1 when the latter is installed on the wall without requiring removal of the supporting frame 1 from the wall.

With reference to FIGS. 3 and 4, advantageously, the protection device 21 according to the present invention includes a protective part 28, connected to the base part 22, surrounding the through opening 27 provided in the base part 22 so as to define at least one protection chamber 41, provided with one open side which is such as to house internally frontal portions of one or more electrical apparatuses 40 intended to be fixed to the supporting frame 1. Preferably, said protective part 28 is formed by walls perpendicular to the base part 22 which project perpendicularly to it.

In a particularly advantageous embodiment, said protective part 28 is represented by a projecting wall which surrounds the opening 27 to form a protruding collar 28 which extends co-axially to the opening 27 (and, therefore, also to the mounting window 7 of the supporting frame 1). In a preferred embodiment, said collar projects from the base part by a distance between 0.6 cm and 1.5 cm.

In a particularly advantageous embodiment, the protective part 28 (as, for example, in the case of the protruding collar 28) is shaped in such a way as:
to allow fixing of the electrical apparatuses 40 to the supporting frame 1 when the protection device 21 is applied to the supporting frame 1;
to allow removal of the protection device 21 from the supporting frame 1 without requiring removal of the electrical apparatuses 40 from the supporting frame 1.

It should also be observed that, advantageously, the presence of a protective chamber 41 with one open side, permits full utilization of the electrical apparatuses 40 even when the protection device 21 is applied to the supporting frame 1. In other words, the electrical system of a building can be fully utilized during the finishing works of the building without removing the protection device 21. For example, FIG. 6 shows how it is possible to insert a plug 45 into a power supply socket 45 fixed to the frame 1 where the protection device 21 is applied.

It has been noted that, although the protection chamber 41, defined by the protective part 23, is provided with one open side, the presence of said chamber 41 in the protection device 21 considerably reduces the probability of accidental damage to the electrical apparatuses 40 during the typical finishing works of a building. Just by way of example, consider the case of sharp-edged objects falling vertically through the protection frame 1, or the example of a trolley which scrapes along the wall where the supporting frame 1 is installed.

With reference to FIG. 6, in the case where complete protection must be guaranteed for the electrical apparatuses 40 installed on the supporting frame 1, optionally the protection device 21 can be provided with a hood 50 removably associated to the protection device 21 so as to temporarily close the open side of the protective chamber 41. This requirement is typically felt during finishing works where splashing or pouring of liquids on the walls is possible, as for example during painting and decorating.

Preferably the hood 50 is made of transparent material, for example hard plastic, so as to be able to see the electrical apparatuses 40. In an alternative embodiment, said hood 50 is made of soft, transparent synthetic material, for example silicone, so as to allow use of some electrical apparatuses 40 which can be switched on by pressure (for example, push buttons of the lighting system) without requiring removal of the hood 50. In this way, an operator can, for example, switch a light on or off without worrying about dirtying or staining the electrical apparatuses 40.

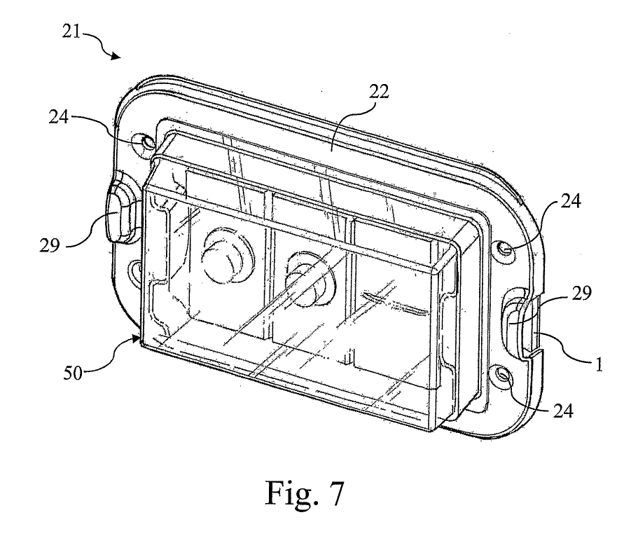

With reference to FIG. 7 where the hood 50 is coupled to the protection device 21, in the particular embodiment where the protective part 28 of the protection device 21 includes a protruding collar 28, the hood 50 can easily be fitted around said collar 28. Moreover, in this case, by producing the hood 50 in silicone, a watertight protection is advantageously obtained.

On the basis of the above description, therefore, it is possible to understand how the protection device 21 is such as to fully overcome the above mentioned drawbacks with reference to the known art.

It should also be observed that a protection device 21 according to the present invention can be produced with low cost materials, so that it can be considered as a disposable element (possibly recyclable) supplied together with each supporting frame 1 and, for example, conveniently supplied already applied to the respective supporting frame 1, so as to form a group of parts already ready for wall installation. Furthermore, said protection device 21 and, in particular, its protective part 28, can be provided with shaped profiles 30 which make it possible to form stacks of groups of parts composed of protection devices 21 and respective frames 1, so as to create convenient compact selling blocks of numerous groups of parts piled one on another.

When the construction or work is completed, the protective cover 21 can be removed easily and discarded. The main body 2 and the supporting frame 1 have not been damaged and are now clean and ready for customer use. The frame 1 has thus been protected during this construction phase and could be used to provide electric power by the workers during construction without concern that they would damage or marr it.

Naturally, in order to satisfy contingent and specific requirements, a person skilled in the art may apply to the above-described protection device and group of parts according to the invention many modifications and variations, all of which, however, are included within the scope of protection of the invention as defined by the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. Protection device for protecting at least one electrical apparatus which can be fixed to a wall by means of a supporting frame including a main body provided with at least one mounting window suitable to receive said electrical apparatus,
the protection device comprising:
a base part configured to face said main body and be removably applied to the supporting frame, provided with at least one through opening suitable to align with said at least one mounting window;
a protective part, connected to the base part, which includes a projecting wall surrounding the through opening so as to form a protruding collar and to define at least one protection chamber provided with one open side, the protective part being such as to internally house said electrical apparatus; and
said base part configured to couple to the main body of the supporting frame, said base part being a substantially plate-like mask having a shape which has portions that extend through the opening of the main body and which is substantially counter-shaped compared to a front face of the body of the supporting frame.

2. Protection device according to claim 1, wherein said projecting wall surrounds the through opening to form a protruding collar which extends co-axially to the through opening.

3. Protection device according to claim 1, wherein said projecting wall is disposed at a border of said through opening.

4. Protection device according to claim 1, wherein said protection device can be removably applied to the supporting frame by means of fixing means such as to interact with complementary fixing means provided in the supporting frame in order to apply a covering plate, distinct from said protection device, to the supporting frame.

5. Protection device according to claim 1, wherein said protective part is shaped in such a way as:
to allow fixing of said electrical apparatus to the supporting frame when the protection device is applied to the supporting frame;
to allow removal of the protection device from the supporting frame without requiring removal of said electrical apparatus from the supporting frame.

6. Protection device according to claim 1, further including a hood removably associated to said protection device in order to temporarily close said open side.

7. Protection device according to claim 6, wherein said hood is such that it can be fitted on said collar.

8. Protection device according to claim 6, wherein said hood is made of transparent material.

9. A group of parts for wall mounting of at least one electrical apparatus, comprising:
a supporting frame including a main body provided with at least one mounting window suitable to receive said electrical apparatus;
a protection device including:
a base part configured to face said main body and which can be removably applied to the supporting frame, provided with at least one through opening such as to align with said at least one mounting window;
a protective part connected to the base part, which includes a projecting wall surrounding the through opening so as to form a protruding collar and to define at least one protection chamber provided with one open side, the protective part being such as to internally house at least a frontal portion of said electrical apparatus; and
said base part being configured to couple to the main body of the supporting frame, said base part being a substantially plate-like mask having a shape which has portions that extend through the opening of the main body and which is substantially counter-shaped compared to a front face of the main body of the supporting frame.

10. A group of parts according to claim 9, wherein said projecting wall which surrounds the through opening to form a protruding collar which extends co-axially to the through opening.

11. A group of parts according to claim 9, wherein said protective part includes shaped profiles which make it possible to stack on said group of parts another identical group of parts.
